(19) United States
(12) Patent Application Publication
(10) Pub. No.: US 2007/0290977 A1
(43) Pub. Date: Dec. 20, 2007

(54) APPARATUS FOR DRIVING LIQUID CRYSTAL DISPLAY AND METHOD THEREOF

(76) Inventors: Jung-Chieh Cheng, Changhua County (TW); Chih-Liang Wu, Chiayi County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,089

(22) Filed: Jun. 20, 2006

(51) Int. Cl. G09G 3/36

(52) U.S. Cl. 345/98

(57) ABSTRACT

An apparatus for driving a liquid crystal display (LCD) includes a timing controller, a source driver and a gate driver. A panel of the LCD includes gate line groups, and each of the gate line groups includes gate lines. Scan pulse signals having a same scan pulse period and output enable signals are generated by the gate driver. The scan pulse signals are respectively enabled by the output enable signals and each of the scan pulse signal has one of a data writing period and a gray level writing period during the scan pulse period. During the data writing period, only one of the gate lines is turned on at a point in time by the scan pulse signals. During the gate level writing period, one of the gate line groups is turned on by the scan pulse signals. Thus, the edge blur of displaying moving images is eliminated.

### BACKGROUND OF THE INVENTION

1. Field of Invention

The present invention relates to an apparatus for driving a flat panel display, more particularly to an apparatus for driving a liquid crystal display (LCD) and the method thereof for improving display quality by simultaneously turning on a plurality of gate lines and inserting black data.

2. Description of Related Art

Among consumer electronic devices, liquid crystal displays (LCDs) provide entertainment and real-time images, etc., thus, they usually display moving images, especially for LCD televisions. However, since LCDs are of the hold-type light emitting mode and the response speed of the liquid crystal is slow, the problem of edge blur of the viewed images often occurs due to the integration effect of the human eye when the user watches moving images displayed by an LCD.

In the conventional art, the methods for improving the display quality of moving images mainly include overdrive and black insertion. Referring to FIG. 1, it depicts a driving waveform diagram of another conventional black insertion method, which is disclosed in US Patent Application No. 2002/0084959. In the disclosed method, the scan pulse signal on the gate line G1 is divided into a first period 205 and a second period 208 by a gate enable signal GOE1, wherein the scanning pulse SP on the gate line G1 is in the first period 205; . . . ; the scan pulse signal on the gate line GL32 is divided into the first period 205 and the second period 208 by another gate enable signal, wherein the scanning pulse SP on the gate line GL32 is in the second period 208. Thus, in the cycle of the same scan pulse signal, for example, a normal data D can be written onto the gate line GL1 in the first period 205, and the black data B can be written onto the gate line GL32 in the second period 208 respectively. In this way, the edge blur can be reduced, but the operating frequency for the source driver must be increased, thus increasing the circuit complexity of the source driver; and meanwhile, the charge time for the liquid crystal pixels is shortened, thus affecting the display quality.

### SUMMARY OF THE INVENTION

An object of the present invention is to provide an apparatus for driving a liquid crystal display (LCD), wherein a plurality of scan pulse signals having the same scan pulse period are utilized, combined with a plurality of output enable signals, thus achieving the object of black insertion, and thereby reducing the edge blur and improving display quality.

Another object of the present invention is to provide a method for driving an LCD, wherein the output enable signals are used to control the data writing timing and gray level writing timing in the scan pulse signal, such that the pixel has a longer charge time, and the object of black insertion can be achieved, thereby reducing the edge blur and improving display quality.

To achieve the above and other objects, an apparatus for driving an LCD is provided, wherein the LCD includes a panel, the panel includes a plurality of gate line groups, and each of the gate line groups includes a plurality of gate lines. The apparatus includes a timing controller, a source driver and a gate driver. Wherein, the timing controller is used to receive an image signal and output a source signal, a gate signal and an enable control signal. The source driver, electrically connected to the timing controller, outputs a data signal and a gray level signal according to the source signal. The data signal is above-mentioned normal data, and the gray level signal can be one gray level data depending on the design. In an embodiment of the present invention, the gray level signal is above-mentioned black data.

The gate driver, electrically connected to the timing controller, provides a plurality of scan pulse signals having a same scan pulse period according to the gate signal, and generates a plurality of output enable signals according to the enable control signal. The scan pulse signals are respectively enabled by the output enable signals and each scan pulse signal has one of a data writing period and a gray level writing period during the scan pulse period. During the data writing period, only one of the gate lines is turned on at a point in time by the scan pulse signal, and pixels, corresponding to the gate line which has been turned on, receive the data signal output by the source driver. During the gray level writing period, one of the gate line groups is turned on by the scan pulse signal, and pixels, corresponding to the gate line group which has been turned on, receive the gray level signal output by the source driver. Thus, the data signal is written by one gate line each time, and the gray level signal is written by gate lines (or a gate line group) each time simultaneously. Accordingly, the writing time for pixel can be increased, and the operating frequency for the gate driver can be reduced.

In another aspect, a method for driving an LCD is provided. The method is used for driving a panel of the LCD, wherein the panel includes a plurality of gate line groups, and each of the gate line groups includes a plurality of gate lines. The driving method includes the following steps. First, an enable control signal is provided, and then a plurality of scan pulse signals having a same scan pulse period are provided. Next, output enable signals corresponding to the scan pulse signals are generated according to the enable control signal; and the scan pulse signals are respectively enabled by the output enable signals and each scan pulse signal has one of a data writing period and a gray level writing period during the scan pulse period, so as to control the gate line in the panel. During the data writing period, only one of the gate lines is turned on at a point in time, and pixels, corresponding to the gate line that has been turned on, receive the data signal. During the gray level writing period, one of the gate line groups is turned on, and pixels, corresponding to one of the gate line groups that has been turned on, receive the gray level signal.

In an embodiment, the gate driver further includes a shift register and a level shifter. According to the gate signal and the enable control signal provided by the timing controller, the shift register temporarily stores the scan pulse signals and shifts them toward the next gate line group to act as the pulse signal for controlling the next gate line group. The level shifter is used for adjusting the voltage levels of the scan pulse signals.

In an embodiment, the gate driver further includes a plurality of output enable units, and each of the output enable units generates an output enable signal according to the enable control signal. Wherein, the output enable signals have different enable periods during the data writing period, and has the same enable period during the gray level writing period.

According to a preferred embodiment of the present invention, as for the method for driving an LCD, the step in which a plurality of output enable signals corresponding to the scan pulse signals are generated according to the enable control signal, and the scan pulse signals are enabled by the output enable signals and have a data writing period and a gray level writing period, further includes the following steps in an embodiment: first, whether the output enable signals are in the data writing period or in the gray level writing period is determined; if they are in the data writing period, a phase difference is sequentially generated for each output enable signal, thus each output enable signal is provided with a different enable period; and if they are in the gray level writing period, the same phase is generated for all of the output enable signals, thus each output enable signal is provided with the same enable period.

In the present invention, the scan pulse signals having the same scan pulse period are employed in combination with the output enable signals to control the data writing period and the gray level writing period of the signals outputted by the gate driver, thus the number of shift registers is greatly reduced, black insertion is achieved with a relatively low operating frequency, the edge blur of displaying moving images is diminished, and the charge time of pixels is maintained longer, thereby display quality is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a driving waveform diagram of a conventional black insertion method.

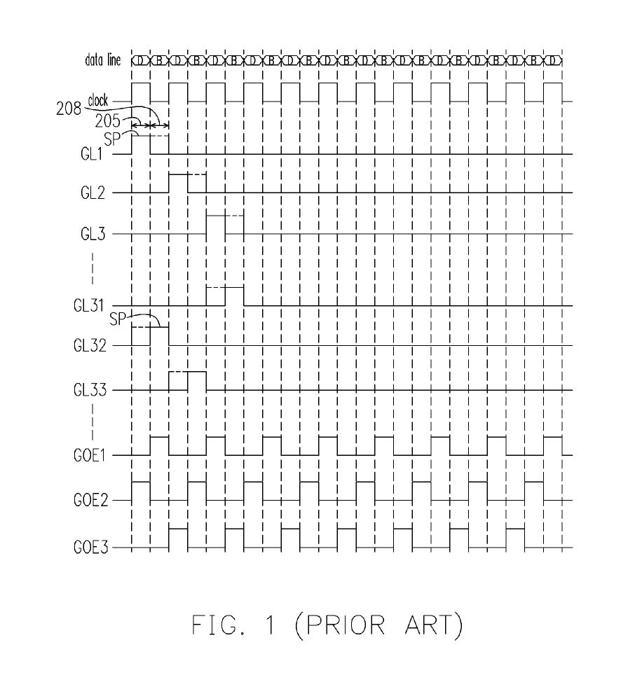

FIG. 2 is a block diagram of a liquid crystal display (LCD) apparatus according to an embodiment of the present invention;

FIG. 3 is a waveform timing diagram of the scan signal according to an embodiment of the present invention;

FIG. 4 is a flow chart of a method for driving an LCD according to an embodiment of the present invention; and

FIG. 5 is a flow chart for the output control of the output enable unit according to an embodiment of the present invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

To reduce the edge blur of the liquid crystal display (LCD) when displaying moving images, in an embodiment of the present invention, a plurality of scan pulse signals having the same scan pulse period are generated by the gate driver, combined with a plurality of output enable signals, so as to turn on a plurality of gate lines and input gray level signals such as black data, thus reducing the edge blur of the LCD while maintaining the pixel charge time as the conventional art. Meanwhile, with the architecture of the present invention, the operating frequency of the gate circuit and the complexity of the circuit can also be reduced.

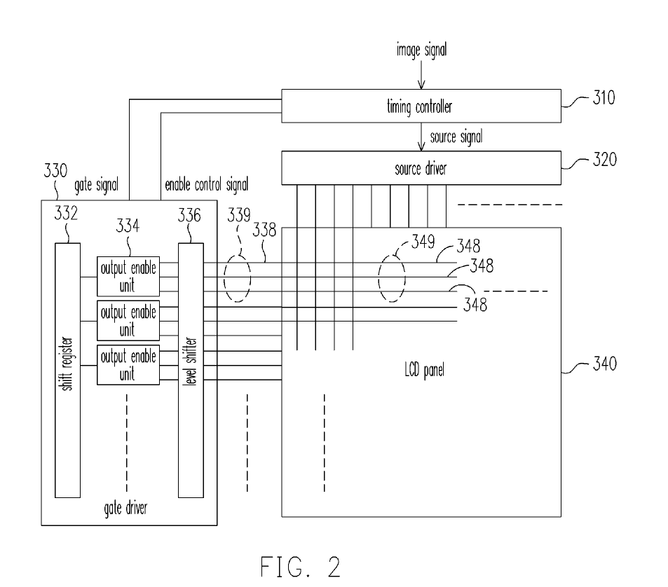

Referring to FIG. 2, it is a block diagram of an apparatus for driving an LCD according to an embodiment of the present invention. The apparatus includes a timing controller 310, a source driver 320 and a gate driver 330. The timing controller 310 receives an image signal and outputs a source signal, a gate signal and an enable control signal according to the image signal. The source driver 320 electrically connected to the timing controller 310 outputs a data signal and a gray level signal according to the source signal output by the timing controller 310. The data signal is above-mentioned normal data, and the gray level signal can be one gray level data depending on the design, for example, the gray level signal is above-mentioned black data in an embodiment of the present invention. The gate driver 330 electrically connected to the timing controller 310 generates a plurality of scan pulse signals 338 simultaneously according to the received gate signal, so as to control a plurality of gate lines 348 in the panel 340. In addition, a plurality of output enable signals are generated by the gate driver 330 according to the enable control signal, and the scan pulse signals 338 are enabled by the output enable signals and each scan pulse signal 338 has one of a data writing period and a gray level writing period during the scan pulse period.

The scan pulse signals 338 for controlling the gate lines 348 in the panel 340 are further illustrated. The gate lines 348 included in the LCD panel 340 are divided into groups, wherein every several gate lines 348 form a gate line group 349, and the gate line groups 349 are controlled by the corresponding scan pulse signal groups 339 respectively. In this embodiment, taking three gate lines 348 as one gate line group 349 for example, each scan pulse signal group 339 includes three scan pulse signals 338, wherein each scan pulse signal 338 in the individual scan pulse signal group 339 has the same scan pulse period. That is to say, the scan pulse signals 339 in the same group have the same scan pulse. Generally, the preferred number for group division is 3-10 gate lines 348 in a group.

Taking the gate line group 349 as an example, during the data writing period, only one corresponding gate line 348 in the gate line group 349 is turned on by the scan pulse signal group 339 in the same period for preventing the same data signal from being written to the pixels of the gate lines 348. When one gate line 348 is turned on, the source driver 320 outputs the data signal to the pixels of the corresponding gate line 348. During the gray level writing period, all of the gate lines 348 in the gate line group 349 are turned on by the scan pulse signal group 339. When the gate lines are turned on, the source driver 320 outputs the gray level signal such as above-mentioned black data to the pixels corresponding to the gate line group 349.

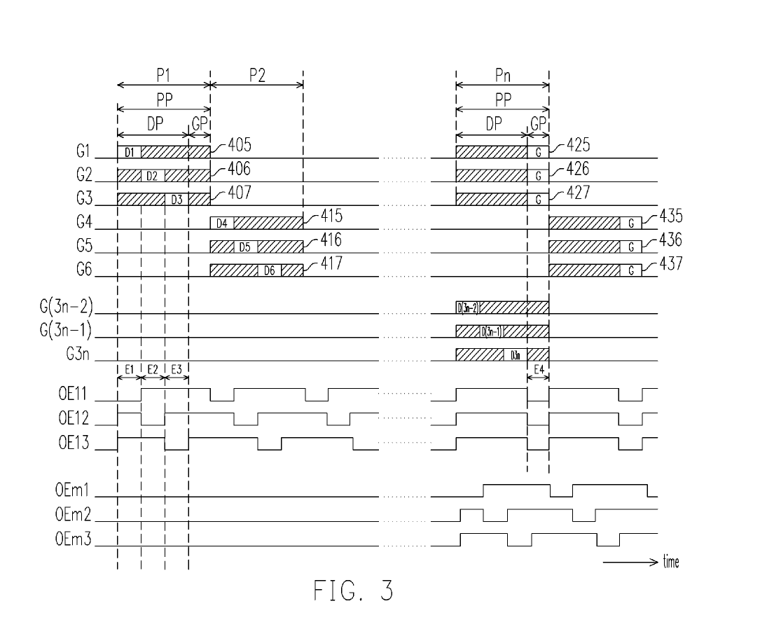

The gate driver 330 further includes a shift register 332, output enable units 334 and a level shifter 336. The displacement, waveform adjustment and the voltage level adjustment are respectively carried out by the above-mentioned three elements to each of the scan pulse signals 338 before the outputting process. To help those skilled in the art to further understand the technical features of the present invention, the following description will be illustrated with reference to FIG. 3. Referring to FIG. 3, it depicts a timing diagram of the waveform of scan signals according to an embodiment of the present invention. The gate line timings G1-G3n represent the timing diagram for different gate lines 348 respectively. In this embodiment, taking three gate lines 348 as a gate line group 339 for illustration, the gate line timings G1-G3 as a group corresponds respectively to three gate lines 348 in the gate line group 349 as shown in FIG. 3, and the gate line timings G1-G3 have the same scan pulse signals 405-407. Each of the scan pulse signals 405-407 has the same scan pulse period PP, and during the scan pulse period PP, the gate lines 338 are not all turned on, but only when the scan pulse signal is enabled, the corresponding gate line 338 is turned on according to the enable control signal.

The output enable unit 334 outputs a group of output enable signals OE11-OE13 according to the enable control signal, and this group of output enable signals OE11-OE13 corresponds to the gate line timings G1-G3 respectively and generates pulse timings for the scan pulse signals 405-407 to turn on the individual gate line 348. In other words, so long as the output enable signals OE11-OE13 are the enable levels, the scan pulse signals 405-407 can turn on the corresponding gate lines 338. As shown in FIG. 3, during the data writing period DP, the output enable unit 334 outputs a group of output enable signals OE11-OE13 with phase differences, and each of them has a different enable period E1-E3. In the first period P1, when the output enable signal OE11 is an enable level (a low level in this embodiment), the scan pulse signal 405 forms a data writing pulse D1 on the gate line timing G1 during the enable level, i.e. turning on the corresponding gate line 348 on the gate line timing G1. The source driver 320 writes the data signal to the pixels of the corresponding gate line 348 of the gate line timing G1, and so forth. The data writing pulses D2-D3 on the gate line timing G2-G3 are shown in FIG. 3 respectively.

According to the results for the scan pulse signals 405-407 being enabled by the output enable signals OE11-OE13, data writing pulses D1-D3 are generated respectively during the data writing period DP. Therefore, during the first period P1 of the data writing period DP, only one corresponding gate line 348 is turned on in an individual given time period for the gate line timing G1-G3. The shift register 332 transmits and shifts the group of gate line timings G1-G3 towards the next gate line group 349, and three gate line timings are shifted each time in this embodiment.

The scan pulse signals 415-417 have data writing pulses D4-D6 respectively, and the gate line timings G4-G6 are used to turn on the corresponding gate lines 348 respectively in the individual data writing pulses D4-D6, and so forth. During the data writing period DP, each of the gate line timings G(3n−2)˜Gn is enabled by the output enable signals OEm1-OEm3 generated by the corresponding output enable unit 334, and outputs corresponding data writing pulses D(3n−2)˜D3n, where n, m are positive integers. Then, three scan pulse signals are taken as a group and then transmitted on to the next group sequentially, so the operating frequency of the shift register 332 is lower than that of the shift registers in a typical gate driver, at the same time, the circuit elements required for the shift register 332 are also greatly simplified.

When the gate line group 349 requires turning on to write a gray level signal to controlled pixels, in the n^{th} period Pn, the gate line timings G1-G3 have three same pulse signals: scan pulse signals 425-427, and each of the scan pulse signals 425-427 has the same scan pulse period PP. The corresponding output enable signals OE11-OE13 generate an enable level (a low level in this embodiment) in the gray level writing period GP according to the enable control signal output from the timing controller 310, and disenable levels (high levels in this embodiment) are generated outside the gray level writing period GP. Therefore, the gate line timings G1-G3 all have a gray level writing pulse G in the data writing period GP, and at the same time the corresponding gate lines 348 of the gate line timings G1-G3 are turned on. During the gray level writing period GP, the source driver 320 writes the gray level signals to the pixels of the gate lines that are turned on by the gate line timings G1-G3. The main function of the gray level signal, which is generally the gray level signal such as above-mentioned black data, is to reduce the integration effect of the human eye.

The shift register 332 is also used to sequentially shift the scan pulse signals 425-427 to the next group of scan line timings G4-G6 after one scan pulse signal period PP as shown by the scan pulse signals 435-437 in FIG. 3, and forms a gray level writing pulse G with the corresponding output enable signals within the same period. Each of the scan pulse signals has one of the data writing period DP and the gray level writing period GP during the scan pulse period PP. That is to say, each of the scan pulse signals has the data writing period or the gray level writing period during the scan pulse period, wherein if having the data writing period DP, each of the scan pulse signals has a data writing pulse in a different period, and if having the gray level writing period GP, each of the scan pulse signals has a gray level writing period G in the same period. In periods outside data writing and gray level writing pulses, the scan pulse signals cannot turn on the corresponding the gate lines 348 due to the disable levels (high levels in this embodiment) of the output enable signals OEm1-OEm3.

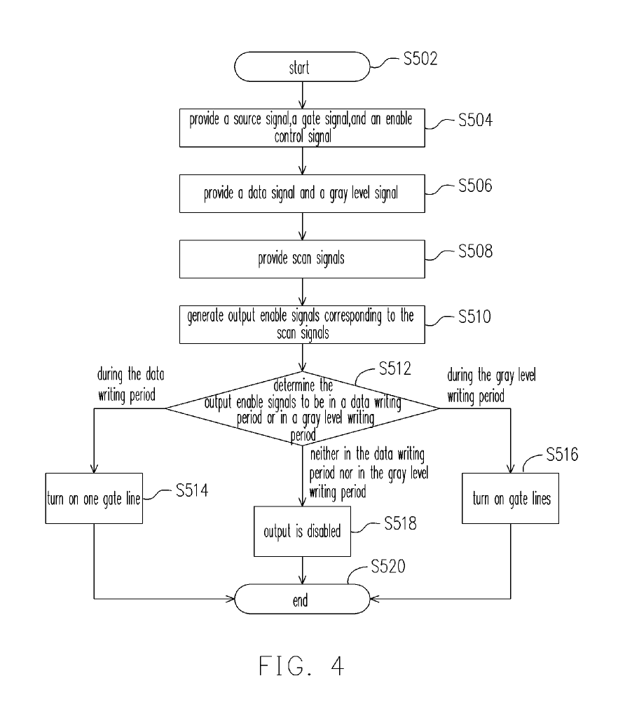

FIG. 4 is a flow chart of a method for driving an LCD according to an embodiment of the present invention. To help those skilled in the art to further understand the technique features of the present invention, the method is further illustrated with reference to FIGS. 2 and 3. It begins from step S502. First of all, at step S504, a source signal, a gate signal and an enable control signal are provided. At step S506, a data signal and a gray level signal are provided. Then, at step S508, scan pulse signals 405-407 having the same scan pulse period are generated according to the gate signal. Then it comes to step S510, wherein output enable signals OE11-OE13 corresponding to the scan pulse signals 405-407 are generated according to the enable control signal, and the scan pulse signals 405-407 are enabled by the output enable signals OE11-OE13 and each scan pulse signals 405-407 has one of the data writing period DP and the gray level writing period GP during the scan pulse period to control gate lines 348.

Then, at step S512, whether the output enable signals are in the data writing period DP or in the gray level writing period GP is determined. If the output enable signals OE11-OE13 are in the data writing period DP, it goes to step S514, wherein the output enable signals OE11-OE13 generate the enable levels (low levels in this embodiment) in different enable periods E1-E3 respectively, such that only one gate line 348 is turned on in an individual given period by the scan pulse signals 405-407 during the data writing period DP, and the data signal is output to the pixels corresponding to the gate line 348 that has been turned on.

If the output enable signals OE11-OE13 are in the gray level writing period GP, it goes to step S516, wherein the output enable signals OE11-OE13 generate the enable levels (low levels in this embodiment) in the same enable period E4 respectively, as shown in the n^{th} period Pn. The scan pulse signals 425-427 generate the gray level pulse G in the gray level writing period GP, turn on all of the gate lines 348 in the gate line group 349, and output the gray level signals to the pixels corresponding to the gate line group 349 simultaneously. In the period outside the data writing period and the gray level writing period, the scan pulse signals 405-407 are disabled by the output enable signals OE11-OE13. If the output enable signals are not in the data writing period or the gray level writing period, it goes to step S518 to output disabling, that is, no signals are output. Finally, the flow chart is ended at step S520. Other details of the flow chart can be appreciated by those skilled in the art through the illustration of the embodiments of the apparatus, therefore it will not be described any more.

As for the method for driving an LCD, before step S504, receiving image signals is further included. Furthermore, at step S508, sequentially transmitting scan pulse signals is further included, wherein the scan pulse signals are shifted and transmitted with each three scan signals as a group.

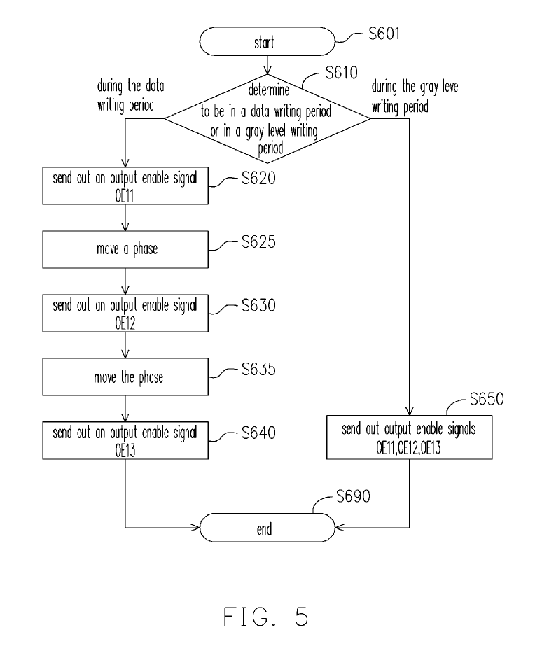

Then, the determining mechanism of determining whether the output enable unit 334 is in the data writing period DP or in the gray level writing period GP is further illustrated with reference to the reference numbers in FIGS. 2 and 3. FIG. 5 is a flow chart for the output control of the output enable unit according to an embodiment of the present invention. It begins from step S601. First, at step S610, the output enable unit 334 determines whether the output enable signals OE11-OE13 to be outputted are in the data writing period DP or in the gray level writing period GP according to the enable control signal of the timing controller 310.

If the output enable signals are in the gray level writing period GP, it goes to step S650, wherein three output enable signals OE11-OE13 having the same phase are output as shown by in FIG. 3, and the output enable signals OE11-OE13 have the same enable period E4 during the n^{th} period Pn. If the output enable signals are in the data writing period DP, it goes to step S620, wherein the output enable signal OE11 is sent out. Next, at step S625, wherein the output enable unit OE11 is moved by one phase via the phase shifter, and the output enable signal OE12 is sent out at step S630. The output enable signal OE12 is moved by one phase at step S635, and the output enable signals OE13 is sent out at step S640. The results are as shown by the first period P1 in FIG. 3: the output enable signals OE11-OE13 have different enable periods E1-E3.

As illustrated in the above embodiments, a determining mechanism for output enable signals is utilized and the gate lines are driven simultaneously according to the present invention, thus the gray level signals such as black data can be inserted into the frame. As a result, the present invention does not only to improve the edge blur of the moving images, but also reduces the operating frequency of the shift register. In the meantime, the length of the pixel charge time is maintained.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for driving a liquid crystal display (LCD), wherein the LCD comprises a panel, the panel comprises a plurality of gate line groups and each of the gate line groups comprises a plurality of gate lines, the apparatus for driving an LCD comprising:
a timing controller for outputting a source signal, a gate signal and an enable control signal;
a source driver electrically connected to the timing controller for outputting a data signal and a gray level signal according to the source signal; and
a gate driver electrically connected to the timing controller for providing a plurality of scan pulse signals having a same scan pulse period according to the gate signal, and generating a plurality of output enable signals according to the enable control signal, so as to make each of the scan pulse signals has one of a data writing period and a gray level writing period during the scan pulse period to drive the gate lines;
wherein, during the data writing period, only one of the gate lines is turned on by the scan pulse signals at a point in time, and pixels corresponding to the gate line that has been turned on receive the data signal output by the source driver; and during the gray level writing period, one of the gate line groups is turned on by the scan pulse signals, and pixels corresponding to the gate line group that has been turned on receive the gray level signal output by the source driver.

2. The apparatus for driving an LCD as claimed in claim 1, wherein the timing controller further receives an image signal and outputs the source signal, the gate signal and the enable control signal according to the image signal.

3. The apparatus for driving an LCD as claimed in claim 1, wherein the gate driver further comprises a shift register, which is used for temporarily storing and shifting the scan pulse signals according to the gate signal.

4. The apparatus for driving an LCD as claimed in claim 1, wherein the gate driver further comprises a level shifter, which is used for adjusting the voltage levels for the scan pulse signals.

5. The apparatus for driving an LCD as claimed in claim 1, wherein the gate driver further comprises a plurality of output enable units, each of the output enable units generating the output enable signals according to the enable control signal.

6. The apparatus for driving an LCD as claimed in claim 5, wherein during the data writing period, the output enable signals have different enable periods.

7. The apparatus for driving an LCD as claimed in claim 5, wherein during the gray level writing period, each of the output enable signals has a same enable period.

8. The apparatus for driving an LCD as claimed in claim 1, wherein the gray level signal comprises black data.

9. A method for driving an LCD, wherein the LCD comprises a panel, the panel comprises a plurality of gate line groups and each of the gate line groups comprises a plurality of gate lines, the method for driving an LCD comprising:
providing an enable control signal;
providing a plurality of scan pulse signals having a same scan pulse period;
generating a plurality of output enable signals corresponding to the scan pulse signals according to the enable control signal, so as to make each of the scan pulse signals has one of a data writing period and a gray level writing period during the scan pulse period;
during the data writing period, turning on only one of the gate lines at a point in time and pixels corresponding to the gate line that has been turned on receive a data signal; and
during the gray level writing period, turning on one of the gate line groups and pixels corresponding to the gate line group that has been turned on receive a gray level signal.

10. The method for driving an LCD as claimed in claim 9, further comprising receiving an image signal, and providing the data signal according to the image signal.

11. The method for driving an LCD as claimed in claim 9, wherein the step of “generating a plurality of output enable signals corresponding to the scan pulse signals according to the enable control signal, so as to make each of the scan pulse signals has one of a data writing period and a gray level writing period during the scan pulse period for controlling the gate lines” further comprises:
determining whether the output enable signals are in the data writing period or in the gray level writing period;
if they are in the data writing period, adjacent output enable signals have a phase difference, and the output enable signals have different enable periods; and
if they are in the gray level writing period, each of the output enable signals has the same phase, and each of the output enable signals has a same enable period.

12. The method for driving an LCD as claimed in claim 9, wherein the gray level signal comprises black data.
